(19) United States
(12) Patent Application Publication
(10) Pub. No.: US 2024/0368406 A1
(43) Pub. Date: Nov. 7, 2024

(54) STABLE LIQUID PHANTOM FOR NEAR-INFRARED FLUORESCENCE VERIFICATION

(71) Applicant: SURGVISION GMBH, Munich (DE)

(72) Inventors: Francesco BLASI, Rivarolo Canavese (IT); Federico CRIVELLIN, Grugliasco (IT); Christian AICHINGER, Munich (DE); Adrian TARUTTIS, Groningen (NL)

(73) Assignee: SURGVISION GMBH, Munich (DE)

(21) Appl. No.: 18/565,852

(22) PCT Filed: Jun. 1, 2022
(86) PCT No.: PCT/EP2022/064897

§ 371 Date: Nov. 30, 2023

(30) Foreign Application Priority Data
Jun. 7, 2021 (EP) 21177900.4

(51) Int. Cl. C09B 67/44

(52) U.S. Cl. CPC C09B 67/0083

(57) ABSTRACT

The present invention relates to the field of optical imaging. More particularly, it relates to the use of a formulation comprising an organic dye with near-infrared emission, dissolved in a Good's buffer, optionally with further additives as suitable phantom to assess, verify and calibrate near-infrared fluorescence imaging systems. The invention further relates to a validation kit comprising the above formulation and a method for calibrating a fluorescence imaging apparatus.

### FIELD OF THE INVENTION

The present invention relates to the field of optical imaging. More particularly, it relates to the use of a formulation comprising an organic dye with near-infrared emission, dissolved in a Good's buffer as suitable phantom to assess, verify and calibrate near-infrared fluorescence imaging systems.

### BACKGROUND ART

Near-infrared fluorescence imaging devices can be used in clinical practice to provide images of fluorescence in tissues, typically originating from exogenous contrast agents administered to patients before or during the imaging session. Performance verification of such near-infrared fluorescence detection systems is crucial to ensure reproducible and quantitative evaluations. The imaging apparatuses should be tested to verify that they are performing correctly, to avoid possible defects such as degraded excitation light intensity or mechanical issues in the detection optics, which may not be noticed by the user. This is especially important in medical applications, wherein the performance of the imaging apparatuses may affect diagnostic and therapeutic (i.e. surgical) results. However, despite recent advances in fluorescence imaging, the availability of suitable verification systems and standards for the assessment of the sensitivity of imaging systems remains an unmet need.

The test of the imaging apparatuses may be carried out with specific metering instruments. However, this does not allow verifying an illumination unit and an acquisition unit of the imaging apparatuses simultaneously.

Another possibility is the use of a curable polyurethane matrix or a composite phantom embedding quantum dots (small particles manufactured in a semiconductor process) in different concentrations, for example as described in U.S. Pat. No. 9,167,240, relating to methods and compositions of solid phantoms for validation of fluorescence imaging and tomography devices, and in Gorpas et al., J. Biomed. Opt. 2017, 22(1): 016009, describing the use of a composite solid phantom for validation and standardization of fluorescence imaging devices. However, the composite phantom is complex to produce and to control, and the quantum dots exhibit very high absorption of visible light (particularly, far higher than the one of the fluorescence agents typically used in medical applications), so that they may be used to verify the performance of the imaging apparatuses only in environments with a controlled illumination.

Alternatively, tissue-mimicking phantoms have been designed by combining materials with absorption and scattering properties similar to human tissue (for instance hemoglobin and intralipid) with organic fluorophores like Indocyanine Green (ICE). An example of such phantoms is described in US2006-056580 and in De Grand et al., J. Biomed. Opt. 2006, 11(1): 014007, disclosing tissue-like solid phantoms for verification of fluorescence imaging systems. However, such kind of phantoms are relatively complex to prepare, so large scale production may be cumbersome as well as quite costly, considering the different materials needed (polymer, scattering agent, absorbing agent, dye, buffer, excipients).

A simpler alternative to these systems is represented by the use of liquid phantoms composed of an organic dye in a suitable buffer. Liquid phantoms are more user-friendly and customizable than solid phantoms, since the dye solution can be filled in disposable equipment commonly found in laboratory or hospital, like multi-well plates, vials or capillary tubes. An example of liquid phantom commonly used is the fluorescein NIST-traceable standard solution marketed by ThermoFisher (code: F36915). However, fluorescein emits in the visible electromagnetic spectrum (515 nm), and no NIST-traceable standards are available for control, validation and calibration of near-infrared fluorescence imaging devices working at wavelengths higher than 650 nm.

Further examples of such phantom solutions are reported by Koller et al., Nat. Commun. 2018, 9(1): 3739 and Hoogstins at al., Mol. Imaging. Biol. 2019, 21(1): 11-18, disclosing the use of a liquid phantom containing a near-infrared dye for verification of intraoperative fluorescence imaging devices and a testing device (holder) named CalibrationDisk (SurgVision) filled before the device verification procedure with vials containing the near-infrared dye solution.

However, these testing devices require manual interventions (for example, on-site preparation), which are operator-dependent and error-prone. Furthermore, stability of most organic dyes in solution is relatively low, and common users lack proper equipment, know-how, procedures and analytical methods to control the quality (i.e. purity, concentration, identity) of the dye solution after preparation and during shelf-life. Moreover, the above references mention the use of a high molecular weight molecule (bevacizumab-8000W), where the NIR dye is conjugated with an antibody, so even in this case such kind of phantoms can be very complex and costly to prepare on a large scale for routine system performance verification. Furthermore, bevacizumab-8000W is dissolved in 2% Intralipid® which is a fat emulsion comprising phospholipids and fatty acids mimicking the human tissues, but it does not allow to properly control the exact concentration of the dye due to optical interference with standard absorbance measurements. Finally, as reported by Ter Weele et al., Eur. J. Pharm. Biopharm. 104 (2016) 226-234, bevacizumab-8000W is stable if formulated in isotonic phosphate buffered sodium chloride solution at pH 7, but the stability decreases when the formulation contains other components, thus the long-term stability of a formulation in 2% Intralipid® is not warranted, introducing a potential bias during routine system performance verification.

Therefore there is the need of a stable and convenient liquid phantom based on an organic near-infrared dye for routine performance evaluation of fluorescence systems for optical imaging working at wavelengths in the near-infrared spectrum.

### SUMMARY OF THE INVENTION

The invention generally relates to the use of a formulation, comprising an organic near-infrared dye dissolved in suitable Good's buffer, as liquid phantom for the verification of near-infrared fluorescence systems.

Said solution may optionally comprise at least one additive.

In particular, the near-infrared dye is a compound of formula (I) as illustrated hereinafter in the detailed description.

The formulation may be supplied within a final container for storage that does not interfere with the near-infrared imaging procedure and does not require additional manipulation from the end-user such as dilutions, partitioning or quality verification.

Accordingly, another aspect of the invention relates to a kit for verification of the performance of a near-infrared fluorescence apparatus comprising a set of containers carrying a formulation of the invention at different concentrations (i.e. different dilutions of the near-infrared dye in the Good's buffer solution) to allow testing the fluorescence apparatus at multiple concentrations simultaneously.

A further aspect of the invention relates to the use of such stable formulation for performance verification of near-infrared fluorescence imaging systems composed at least of an illumination unit and an acquisition unit. Moreover, the invention relates to verification of near-infrared fluorescence imaging systems, intended for biomedical imaging applications, wherein the imaging is microscopic imaging of organic and inorganic substances, cells and subcellular structures, or wherein the imaging is tomographic imaging of tissues and organs. The near-infrared imaging systems can be either a preclinical or a clinical imaging system.

The formulation of the invention may be used for verification of the performance of a near-infrared imaging apparatus before biomedical imaging procedures such as fluorescence endoscopy, fluorescence minimally-invasive surgery or laparoscopy, fluorescence robotic surgery, open field surgery, laser guided surgery, photodynamic therapy, fluorescence lifetime imaging, or a photoacoustic or sonofluorescence method.

In a still further aspect, the present invention refers to a method for performing a fluorescence verification procedure of near-infrared fluorescence imaging system using such stable formulation.

### DESCRIPTION OF THE DRAWINGS

FIG. 1 shows a linear regression plot representing the dye concentration (nM, x axis) vs the fluorescence intensity (average radiant efficiency, y axis) obtained with the data collected from Example 4 (R²=0.999).

### DETAILED DESCRIPTION OF THE INVENTION

A first aspect of the present invention is the use of a formulation comprising a dye of formula (I)

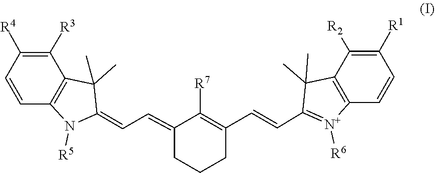

wherein
   R7 is selected from hydrogen, chlorine, phenyl and —O-phenyl, optionally substituted by a group —SO₃H, —COOH, —CONH—Y, -alkyl-COOH or -alkyl-CONH—Y, where
      Y is a bivalent alkyl substituted by —SO₃H or at least two hydroxyl groups;
R1, R2, R3 and R4 are each independently selected from hydrogen, —SO₃H, —COOH and —CONHY, where Y is a bivalent alkyl substituted by —SO₃H or at least two hydroxyl groups, or R1 together with R2 and R3 together with R4 form respectively a benzo-group, optionally substituted by at least one —SO₃H group; and
R5 and R6 are each independently a bivalent alkyl optionally substituted by a group selected from —SO₃H, —COOH and —CONH₂;
which is dissolved in a Good's buffer, optionally comprising at least one additive, as phantom for the verification of the performance of a fluorescence imaging apparatus.

The near-infrared dyes useful for the invention have typically a maximum absorbance in aqueous media comprised between 750 nm and 850 nm and maximum fluorescence emission comprised between 770 and 900 nm. The near-infrared spectrum of the dye is therefore compatible with most of near-infrared imaging systems.

In addition, it was found that the dissolution of a dye of formula (I) in a suitable Good's buffer provides a desirable long shelf-life of the formulation, thus enabling centralized production, storage and remote shipping to testing sites. The components of the formulation of the invention are relatively inexpensive, and the production process is reproducible and amenable for large-scale supply. Standard analytical procedures can be applied to control the quality of the formulation before release.

In a preferred embodiment the near-infrared dye is a compound of the above formula (I), wherein R2 and R3 are hydrogen, i.e. a compound of formula (Ia)

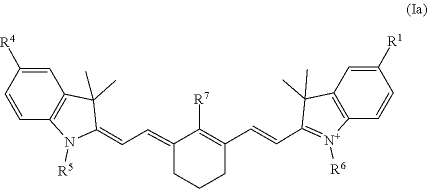

wherein R1 and R4 are each independently selected from hydrogen, —SO₃H, —COOH and —CONHY, where Y is a bivalent alkyl substituted by —SO₃H or at least two hydroxyl groups and R5, R6 and R7 are as defined above.

More preferably, the near-infrared dye is a compound of formula (Ia) wherein R1 and R4 are a group —SO₃H, R5 and R6 are each independently a bivalent alkyl optionally substituted by —SO₃H or —COOH, and R7 is chlorine or —O-phenyl optionally substituted by a group —SO₃H.

In a further preferred embodiment the near-infrared dye is a compound selected from sulfo-Cy7 (CAS Nr.: 2104632-29-1), S0456 (CAS Nr.: 1252007-83-2), IRDye8000W (CAS Nr.: 1088919-86-1) and IRDye800BK (CAS Nr.: 748120-01-6).

In another preferred embodiment the near-infrared dye is a compound of the above formula (I), wherein R1 together with R2 and R3 together with R4 form respectively a benzo-group, i.e. a compound of formula (Ib)

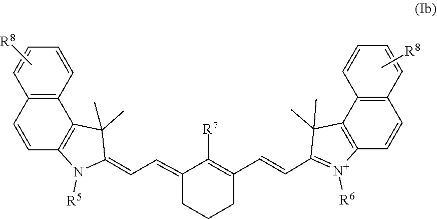

wherein R5, R6 and R7 are as defined above and R8 is each independently hydrogen or —SO₃H.

Preferred compounds of formula (Ib) are represented for instance by IR-820 (CAS Nr.: 172616-80-7) and derivatives thereof.

Preferably, the buffer used for the formulation of the invention is highly soluble in water, has minimal salt effect, is chemically stable, and is optically transparent. In order to conveniently use the formulations of the invention as phantom for the verification of the performance of a fluorescence imaging apparatus, it is required that the buffering agent do not interfere with the absorption and emission properties of the dye, yielding an electromagnetic spectrum in the UV-VIS region comparable to that of the same dye dissolved in distilled water.

In a preferred embodiment the suitable buffer is a zwitterionic biological buffer comprising a bivalent C1-C₄ alkyl substituted by a group —SO₃H or —COOH.

More preferably, the Good's buffer is selected from the group consisting of MOPS (3-(morpholin-4-yl)propane-1-sulfonic acid), MES (2-morpholin-4-ylethanesulfonic acid), TRICINE ({[1,3-dihydroxy-2-(hydroxymethyl)propan-2-yl]amino}acetic acid), HEPES (2-[4-(2-hydroxyethyl)piperazin-1-yl]ethanesulfonic acid), BES (2-[bis(2-hydroxyethyl)amino]ethanesulfonic acid), TES (2-[[1,3-dihydroxy-2-(hydroxymethyl)propan-2-yl]amino]ethanesulfonic acid), TAPSO (3-[[1,3-dihydroxy-2-(hydroxymethyl)propan-2-yl]amino]-2-hydroxypropane-1-sulfonic acid), PIPES (1,4-piperazinediethanesulfonic acid), and the like. Most preferably the buffering compound is selected from MOPS, BES, HEPES and TRICINE.

The chemical structure and the pKa at 20° C. of the preferred Good's buffers are provided in the following Table I.

TABLE I
Chemical structure and pKa at 20° C. of the preferred Good's buffers.

| | | pKa |
|---|---|---|
| | Structure | (20° C.) |
| HEPES | 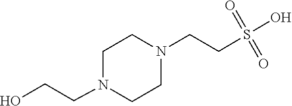 [SMILES: O=S(=O)(O)CCN1CCN(CCO)CC1] | 7.5 |
| MOPS | 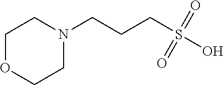 [SMILES: O=S(=O)(O)CCCN1CCOCC1] | 7.2 |
| MES | 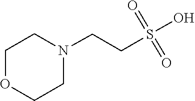 [SMILES: O=S(=O)(O)CCN1CCOCC1] | 6.15 |
| TRICINE | 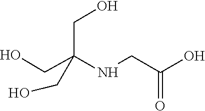 [SMILES: O=C(O)CNC(CO)(CO)CO] | 8.1 |
| BES | 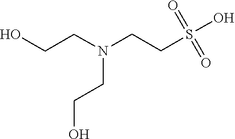 [SMILES: O=S(=O)(O)CCN(CCO)CCO] | 7.2 |
| TES | 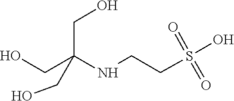 [SMILES: O=S(=O)(O)CCNC(CO)(CO)CO] | 7.5 |
| TAPSO | 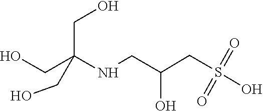 [SMILES: O=S(=O)(O)CC(O)CNC(CO)(CO)CO] | 7.6 |
| PIPES | 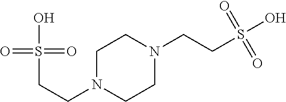 [SMILES: O=S(=O)(O)CCN1CCN(CCS(=O)(=O)O)CC1] | 6.8 |

The formulations defined above have been proven to be stable for a least one month when kept at 2-8° C. and for at least 2 weeks if kept on a workbench at 25° C. Moreover they can be easily prepared from a stock solution that can be stored in a refrigerator.

The near-infrared dye of formula (I) can be easily dissolved in an aqueous solution containing the Good's buffer at concentrations compatible with the sensitivity of common fluorescence detection systems. In particular, such concentrations are not greater than 1 mg/mL. For instance, such concentrations are comprised in the range of 1-1000 μg/mL of solution in case of low sensitivity fluorescence detection systems, and in the range of 1-1000 ng/mL of solutions in case of high sensitivity fluorescence detection systems. Furthermore, for fluorescence detection systems with extremely high sensitivity, the range of concentrations can be 1-1000 μg/mL of solution.

In a preferred embodiment of the invention the near-infrared dye of formula (I) is dissolved in an aqueous Good's buffer at concentrations comprised in the range from 1 nM to 100 nM.

The concentration of the Good's buffer is comprised in the range from 1 mM to 100 mM, more preferably between 5 mM and 50 mM.

In a further embodiment of the invention, the near-infrared dye of formula (I) is dissolved in a Good's buffer solution at a pH value comprised between 6 and 8, more preferably comprised between 6.5 and 7.5.

In another embodiment the formulation of the invention further includes at least one additive. Suitable additives include organic solvents, surfactancts, and antimicrobial substances. Suitable organic solvents include for instance ethanol, methanol, dimethyl sulfoxide, formamide, dimethylformamide, N-methylformamide. Suitable surfactants include for instance polysorbates like Tween 20 and Tween 80, polyethylene glycol of different size distribution (e.g. PEG 40, PEG 100, PEG 300, PEG 400), sodium stearate, sodium lauryl sulfate, Triton X-100 and NP-40. Suitable antimicrobial substances include for instance sodium azide and benzyl alcohol.

In a further aspect the invention provides the use of a formulation as defined above which is provided as a stock solution in a container closure system. The container closure system is suitable to contain a liquid solution without risk of leakage or evaporation. For instance, the container closure system is selected from a bottle, a tube, a vial, a vessel, a storage bag and the like.

Another aspect of this invention relates to a verification kit comprising the stable formulation as defined above contained in a primary packaging suitable for fluorescence detection. The primary packaging is an appropriate container suitable to store liquid solutions. For instance, the primary packaging can be a tube, a vial, an ampule, a syringe, a cuvette, a multi-well plate with suitable lid.

In a further embodiment, the above verification kit comprises a set of multiple primary packagings, e.g. multiple vials or tubes, wherein each primary packaging is pre-filled with a different dilution of a formulation of the invention in aqueous solution of an organic buffering compound as defined above, allowing to test a fluorescence apparatus at multiple concentrations simultaneously.

Preferably the verification kit comprises a set of four primary packages (e.g. tubes) containing a formulation as defined above, wherein the near-infrared dye is present at selected concentrations, such as 0 nM, 2 nM, 8 nM and 32 nM respectively. Optionally, such primary packages can be identified and associated to the different concentrations of the fluorescent dilution by using color-coded caps with a different color for each dilution.

In a further embodiment the primary packaging is contained in a secondary packaging suitable to preserve the quality of the product over time, limiting the exposure of the primary packaging to the light. For instance, the secondary packaging is selected from a cardboard box, an aluminum pouch, an envelope, a sleeve, a canister, a zipper storage bag. The secondary packaging optionally contains also an instruction leaflet.

In another aspect the invention provides a method of calibrating a fluorescence imaging apparatus, comprising the steps of:
a) exposing the verification kit defined above to a suitable excitation source of the fluorescence system;
b) collecting the fluorescence emission with a suitable detection system;
c) recording the fluorescence data with a suitable computerized system.

### Definitions

In the present description, and unless otherwise provided, the following terms and phrases as used herein are intended to have the following meanings.

The term “alkyl” refers to an aliphatic hydrocarbon radical group, which may be a straight or branched chain having from 1 to 6 carbon atoms in the chain. For instance, “C1-C₄ alkyl” comprises within its meaning a linear or branched chain comprising from 1 to 4 carbon atoms. Representative and preferred alkyl groups include methyl, ethyl, n-propyl, iso-propyl, n-butyl, tert-butyl, pentyl and hexyl. Unless otherwise specified, the straight or branched alkyl is a monovalent radical group. In some cases it may be a “bivalent” or “multivalent” radical group, wherein two or more hydrogen atoms are removed from the above hydrocarbon radical group and substituted, e.g. methylene, ethylene, iso-propylene groups and the like.

The expressions “Good's buffer” or “biological buffer” or “buffer” as used herein refers to water soluble organic substances that maintain a constant pH over a given optimal range, typically from 6 to 8 pH, by neutralizing the effects of hydrogen ions. Preferably, they have a pKa value between 6 and 10 and are zwitterionic molecules, derivatives of aminoethane or aminopropane, optionally substituted with sulfonic acid and/or carboxylic acid. Examples of suitable Good's buffers may be selected from the group consisting of MES (2-morpholin-4-ylethanesulfonic acid), Bis-Tris (2-[Bis(2-hydroxyethyl)amino]-2-(hydroxymethyl)propane-1,3-diol), ADA (2,2′,2″-nitrilotriacetic acid), PIPES (1,4-piperazinediethanesulfonic acid), MOPSO (3-morpholino-2-hydroxypropanesulfonic acid), Bis-Tris Propane (1,3-Bis[tris(hydroxymethyl)methylamino]propane), BES (2-[bis(2-hydroxyethyl)amino]ethanesulfonic acid), MOPS (3-(morpholin-4-yl)propane-1-sulfonic acid), TES (2-[[1,3-dihydroxy-2-(hydroxymethyl)propan-2-yl]amino]ethanesulfonic acid), HEPES (2-[4-(2-hydroxyethyl)piperazin-1-yl]ethanesulfonic acid), DIPSO (3-(N,N-Bis[2-hydroxyethyl]amino)-2-hydroxypropanesulfonic acid), MOBS (4-(N-morpholino)butanesulfonic acid), TAPSO (3-[[1,3-dihydroxy-2-(hydroxymethyl)propan-2-yl]amino]-2-hydroxypropane-1-sulfonic acid), HEPPSO (N-(hydroxyethyl)piperazine-N′-2-hydroxypropanesulfonic acid), POPSO (piperazine-N,N′-bis(2-hydroxypropanesulfonic acid)), EPPS (N-(2-hydroxyethyl)piperazine-N′-(3-propanesulfonic acid)), Tricine ({[1,3-dihydroxy-2-(hydroxymethyl)propan-2-yl]amino}acetic acid), Gly-Gly (glycyl-glycine), Bicine (N,N-bis(2-hydroxyethyl)glycine), HEPBS (N-(2-hydroxyethyl)piperazine-N′-(4-butanesulfonic acid)), TAPS ([(2-hydroxy-1,1-bis(hydroxymethyl)ethyl)amino]-1-propanesulfonic acid), AMPD (2-amino-2-methyl-1,3-propanediol), TABS (N-tris(hydroxymethyl)methyl-4-aminobutanesulfonic acid), AMPSO (N-(1,1-dimethyl-2-hydroxyethyl)-3-amino-2-hydroxypropanesulfonic acid), CHES (2-(cyclohexylamino)ethanesulfonic acid), CAPSO 3-(cyclohexylamino)-2-hydroxy-1-propanesulfonic acid, CAPS (3-(cyclohexylamino)-1-propanesulfonic acid) and CABS (4-(cyclohexylamino)-1-butanesulfonic acid) buffer, i.e. biological buffers commonly known as Good's buffers.

The buffers used in the invention are characterized by a solubility in water at 20° C. comprised in the range from about 0.05 M to about 4 M. Preferably, they have a solubility of at least 0.1 M in water.

The expression “buffering solution” refers to an aqueous solution comprising the biological buffer.

The term “zwitterionic compound” refers to a molecule that contains an equal number of positively- and negatively-charged functional groups. It represents typically a dipolar ion with both acid (e.g. carboxylic acid or —SO₃H) and base (e.g. amine) components, such as for instance an amino acid derivative.

The terms “low sensitivity” or “high sensitivity” of the fluorescence detection systems refer to the detection limit of the system, which is the lowest fluorescence signal that can be distinguished from the blank.

### EXPERIMENTAL PART

The invention and its particular embodiments described in the following part are only exemplary and not to be regarded as a limitation of the present invention: they show how the present invention can be carried out and are meant to be illustrative without limiting the scope of the invention.

### Materials and Equipment

IRDye 800CW carboxylate was purchased by LI-COR Inc (Lincoln, Nebraska, USA; code 929-09406, lot C80209-01). S0456 was purchased by Few Chemicals gmbh (Bitterfeld-Wolfen, Germany; code 420456, lot 5114017). IRDye 800BK was synthetized as described in EP 1113822 B1. The purity of IRDye 800BK sodium salt was 99.6% at 776 nm (maximum absorbance).

HEPES, MOPS, MES, BES, TRICINE, Sodium Azide and Tween 20-were purchased from SIGMA. Other reagents were purchased from Merck KGaA and were at least of analytical grade. MilliQ water was used to prepare the buffering agents, which was provided by MilliQ apparatus (Merck Millipore).

The stability studies were performed using the New Brunswick Scientific Innova 4230 Incubator Shaker (Marshall Scientific LLC). Absorbance, excitation and emission values were assessed using a SPECORD 200 PLUS Spectrophotometer (Analytik Jena GmbH).

The tests of the fluorescence imaging were performed with preclinical fluorescence imaging system IVIS Spectrum (Perkin Elmer).

### List of Abbreviations

BES 2-[Bis(2-hydroxyethyl)amino]ethanesulfonic acid (CAS number: 10191-18-1)
EtOH Ethanol
HEPES 2-[4-(2-hydroxyethyl)piperazin-1-yl]ethanesulfonic acid (CAS number: 7365-45-9)
MES 2-morpholin-4-ylethanesulfonic acid (CAS number: 4432-31-9)
MOPS 3-(morpholin-4-yl)propane-1-sulfonic acid (CAS number: 1132-61-2)
PIPES 1,4-Piperazinediethanesulfonic acid (CAS number: 5625-37-6)
PBS Phosphate-buffered saline
TAPSO 3-[[1,3-dihydroxy-2-(hydroxymethyl)propan-2-yl]amino]-2-hydroxypropane-1-sulfonic acid (CAS number: 68399-81-5)
TES 2-[[1,3-dihydroxy-2-(hydroxymethyl)propan-2-yl]amino]ethanesulfonic acid (CAS number: 7365-44-8)
TRICINE {[1,3-Dihydroxy-2-(hydroxymethyl)propan-2-yl]amino}acetic acid (CAS number: 5704-04-1)
Tween 20 Polyethylene glycol sorbitan monolaurate

### Example 1: Preparation of Organic Buffering Solutions

Aqueous solutions containing an organic buffering compound, suitable for dissolving a near-infrared dye of formula (I), were prepared for instance as reported in the following procedures for some representative buffering compounds:

a) 50 mM HEPES (pH 7.4): to prepare 500 mL of 50 mM buffering solution, 5.96 g of HEPES were dissolved in 450 mL of water. The pH of the solution was adjusted to 7.4 by adding HCl 0.1 M. The buffering solution was then brought to 500 mL volume with water, filtered on 0.22 μm membrane in sterile conditions and stored up to 3 months at +2-8° C.
b) 50 mM MOPS (pH 7.0): 5.23 g of MOPS were dissolved in 450 mL of water and a procedure analogous to example a) was followed to obtain the desired pH and volume.
c) 50 mM TRICINE (pH 8.0): 4.48 g of TRICINE were dissolved in 450 mL of water and a procedure analogous to example a) was followed to obtain the desired pH and volume.
d) 50 mM MES (pH 6.2): 4.88 g of MES were dissolved in 450 mL of water and a procedure analogous to example a) was followed to obtain the desired pH and volume.
e) 50 mM PBS (pH 7.4): to prepare 100 mL of 50 mM PBS solution for comparison experiments 0.72 g Na₂HPO₄, 4 g NaCl and 0.1 g KCl were dissolved in 100 mL of water.

The solution was filtered on 0.22 μm membrane in sterile conditions and stored up to 3 months at +2-8° C.

### Example 2: Preparation of a Stock Solution (IRDye 800CW Dissolved in 50 mM HEPES pH 7.4)

A Stock Solution of IRDye 8000W was prepared by dissolving IRDye 8000W carboxylate in 50 mM HEPES buffering solution at pH 7.4, prepared as described in Example 1, a). For instance, 20 nmol of IRDye 8000W were dissolved in 3 mL of 50 MM HEPES solution.

The exact concentration of the Stock Solution was determined by UV/VIS at 774 nm using the Lambert-Beer equation:

A=εcl

where A is the measured absorbance, c is the molar concentration, I is the optical path length and ε is the molar extinction coefficient of the dye (i.e. ε is 240,000 M⁻¹ cm⁻¹ for IRDye 8000W).

The measurement of the concentration of IRDye 8000W carboxylate in the Stock Solution prepared as described above and diluted 1:2 with HEPES buffer revealed a concentration of 4.27±0.05 μM (mean of three measurements).

### Example 3: Preparation of a Verification Kit (Working Solution)

From the Stock Solution prepared as described in Example 2, three different dilutions in HEPES buffer were performed to obtain 70 mL of Working Solutions at the concentration of 32 nM, 8 nM and 2 nM, by diluting respectively 225 μL, 56.2 μL and 14 μL of Stock Solution in volumetric flasks to 30 mL of final volume with HEPES buffer.

For each IRDye 8000W Working Solution (32, 8, 2 nM) 30 transparent plastic vials were filled with a volume of 1.6 mL of Working Solution and capped with a color-coded screw cap (green for 32 nM, orange for 8 nM and yellow for 2 nM). Moreover, 30 vials coded as “Blank” (0 nM) were filled with HEPES buffer, using the same procedure, and capped with a transparent screw cap.

Each of the above kits (32, 8, 2, 0 nM vials) was placed in an individual aluminum foil envelop and labelled. The kits were stored at +2-8° C.

### Example 4: Fluorescence Imaging Verification Test

The verification kit, prepared as described in Example 3 and composed of 3 vials containing the Working Solution (i.e., 32 nM, 8 nM, 2 nM) and a vial containing the HEPES buffer (0 nM, blank) stored in aluminum foil envelop at +2-8° C., was removed from the fridge and let to equilibrate at room temperature for 30-60 min. The vials were then removed from the envelop and positioned within the acquisition chamber of the preclinical imaging system IVIS Spectrum. Fluorescence imaging was performed with an excitation of 745±15 nm and detection of 800±10 nm, using predefined acquisition settings. At the end of the imaging session, a fluorescence image of the phantom kit was obtained.

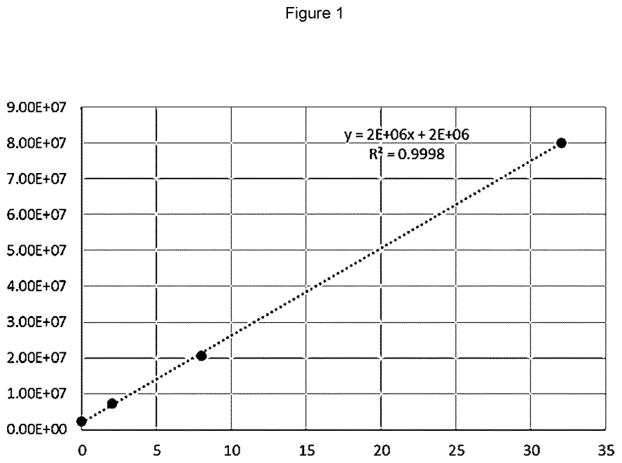

The signal intensity was calculated by placing a region of interest on each of the 4 vials of the kit. Fluorescence intensity values were plotted against concentrations to assess linearity. An example of such linearity plots of the dye concentration vs fluorescence intensity, obtained with the verification kit described in Example 3, is shown in FIG. 1. The verification kit revealed a high detection linearity for the tested imaging system in the selected range of concentrations (2-32 nM).

### Example 5: Stability of the Phantom Solutions at +2-8° C.

Several stability studies were performed to evaluate the effect of different buffers, additives such as excipients or preservatives, and storage conditions on the dye formulation. In particular the stability of the formulations after storage at +2-8° C. in a refrigerator was firstly investigated.

Stability was measured as reduction in the absorbance at the maximum wavelength of the dye acquired using a UV/VIS spectrophotometer, denoting reduction of the dye monomer content in solution. All the results were then reported as residual percentage vs the baseline (T=0), wherein at time=0 the percentage is 100%. A decrease in absorbance is associated with the reduction of the concentration of the dye in the formulation buffer, indicating low stability and degradation of the main chromophore species.

In the Tables below the residual absorbance of different dyes, i.e. IRDye 8000W and S0456, in some representative organic buffering solutions is reported after storage of the formulations at +2-8° C. In particular, the dyes IRDye 8000W and S0456 were dissolved at the concentration of 3 μM in 50 mM buffers MES, HEPES, MOPS or TRICINE and the solutions refrigerated for 4 weeks in order to verify their stability.

The results of the residual absorbance are shown in Table II and III, respectively.

Table II also displays the results of a comparative experiment wherein IRDye 8000W was dissolved at the concentration of 3 μM in the inorganic buffer PBS 50 mM (phosphate buffered saline). In this case, the dye-buffer formulation was less stable and, after 4 weeks at +2-8° C., the residual absorbance was lower than 80% due to degradation of the chromophore species.

TABLE II
Residual absorbance percentage of dye IRDye 800CW
(3 μM) in different organic buffers and in PBS

| Time | PBS | MES | HEPES | MOPS | TRICINE |
|---|---|---|---|---|---|
| (weeks) | (50 mM, pH 7.4) | (50 mM, pH 6.2) | (50 mM, pH 7.4) | (50 mM, pH 7.0) | (50 mM, pH 8.0) |
| 1 | 100% | 99.4% | 100.9% | 99.3% | 100.5% |
| 2 | 92.9% | 96.7% | 100.3% | 98.0% | 99.9% |
| 4 | 79.1% | 93.2% | 99.3% | 95.2% | 99.3% |

TABLE III
Residual absorbance percentage of dye S0456
(3 μM) in different organic buffers

| Time | HEPES | MOPS | TRICINE |
|---|---|---|---|
| (weeks) | (50 mM, pH 7.4) | (50 mM, pH 7.0) | (50 mM, pH 8.0) |
| 1 | 99.0% | 98.8% | 99.7% |
| 2 | 98.5% | 98.5% | 98.7% |
| 4 | 96.9% | 96.1% | 97.9% |

The stability of the above solutions checked for 4 weeks (about 1 months) showed a residual absorbance of about 95% or higher.

Moreover, 3 μM solutions of IRDye 800BK dye in MOPS and BES buffers at different concentrations (10 and 50 mM) and different pH conditions were refrigerated at +2-8° C. to check their stability.

The residual absorbance percentage results are shown in Tables IV and V respectively. These data demonstrate that slight variations in the concentration and pH of the buffering compounds do not influence the stability of the phantom formulations.

TABLE IV
Residual absorbance percentage of dye IRDye 800BK (3 μM) in
MOPS buffer at different pH and different buffer concentrations

| Time | pH 7.0 | | pH 7.4 | | pH 7.8 | |
|---|---|---|---|---|---|---|
| (weeks) | 10 mM | 50 mM | 10 mM | 50 mM | 10 mM | 50 mM |
| 1 | 97.9% | 97.4% | 97.9% | 97.5% | 96.9% | 97.0% |
| 2 | 95.7% | 94.6% | 95.3% | 94.9% | 94.1% | 94.0% |
| 4 | 93.7% | 92.0% | 93.6% | 92.6% | 91.1% | 91.3% |

TABLE V
Residual absorbance percentage of dye IRDye 800BK (3 μM) in
BES buffer at different pH and different buffer concentrations

| Time | pH 7.0 | | pH 7.4 | | pH 7.8 | |
|---|---|---|---|---|---|---|
| (weeks) | 10 mM | 50 mM | 10 mM | 50 mM | 10 mM | 50 mM |
| 1 | 97.6% | 96.8% | 97.6% | 97.2% | 96.4% | 95.9% |
| 2 | 94.8% | 93.5% | 94.4% | 94.0% | 92.4% | 91.7% |
| 4 | 92.0% | 90.0% | 91.5% | 90.5% | 88.1% | 89.6% |

The stability of the above solutions checked for 4 weeks (about 1 months) showed a residual absorbance of about 90%.

### Example 6: Stability of the Phantom Solutions at +2-8° C. in the Presence of Additives

The effect of the presence of an additive on the stability of the formulations of the invention has been also investigated.

Further stability studies were performed by storing at +2-8° C. in a refrigerator somee representative formulations of the invention comprising 3 μM IRDye 8000W dissolved in 50 mM HEPES or TRICINE buffer with 0.04% Tween20 or 0.02% Sodium Azide and formulations comprising 3 μM IRDye 800BK dissolved in 10 mM HEPES, MOPS or BES buffer with 10% EtOH. The preparation of the above buffers is described below:

50 mM HEPES (pH 7.4)+0.04% Tween 20: to prepare 100 mL of buffering solution, 1.19 g of HEPES were dissolved in 80 mL of water; 40 μL of Tween 20 were added and the pH was adjusted to 7.4 with 0.1 M HCl. The buffering solution was then brought to 100 mL volume with water and filtered on 0.22 μm membrane in sterile conditions.

50 mM HEPES (PH 7.4)+0.02% Sodium Azide: to prepare 100 mL of buffering solution, 1.19 g of HEPES and 20 mg of Sodium Azide were dissolved in 80 mL of water and the pH was adjusted to 7.4 with 0.1 M HCl. The buffering solution was then brought to 100 mL volume with water and filtered on 0.22 μm membrane in sterile conditions.

10 mM HEPES (PH 7.0)+10% EtOH: to prepare 100 mL of buffering solution, 0.24 g of HEPES were dissolved in 80 mL of water and the pH was adjusted to 7.0 with 0.1 M HCl.

Then, 10 mL of 100% Ethanol were added. The buffering solution was then brought to 100 mL volume with water and filtered on 0.22 μm membrane in sterile conditions.

Analogous solutions were prepared with the same procedure for MOPS, BES and TRICINE buffers.

The results of the stability study, shown in Tables VI and VII in terms of residual absorbance percentage, demonstrate that the presence of additives has no remarkable effects on the stability of the present formulations.

TABLE VI
Residual absorbance percentage of dye IRDye 800CW
(3 μM) in different biological buffers, in
the presence of additives Tween 20 or sodium azide

| | HEPES | | TRICINE | |
|---|---|---|---|---|
| | (50 mM, pH 7.4) | | (50 mM, pH 8.0) | |
| Time | +0.04% | +0.02% | +0.04% | +0.02% |
| (weeks) | Tween 20 | sodium azide | Tween 20 | sodium azide |
| 1 | 100.5% | 96.9% | 97.7% | 97.7% |
| 2 | 95.8% | 92.4% | 93.0% | 93.0% |
| 4 | 92.4% | 89.1% | 89.8% | 89.8% |

TABLE VII
Residual absorbance percentage of dye IRDye 800BK (3 μM)
in different biological buffers, in the presence of 10% EtOH

| | HEPES | MOPS | BES |
|---|---|---|---|
| Time | (10 mM, pH | (10 mM, pH | (10 mM, pH |
| (weeks) | 7.0) +10% EtOH | 7.0) +10% EtOH | 7.0) +10% EtOH |
| 1 | 97.8% | 97.6% | 99.2% |
| 2 | 97.2% | 95.8% | 98.2% |
| 4 | 95.1% | 92.9% | 97.2% |

### Example 7: Stability of the Phantom Solutions at 25° C.

The stability of the formulations under stressed conditions was also investigated. In particular, samples of 3 μM IRDye 8000W dissolved in HEPES or MOPS buffers (all 50 mM) were stored in incubator in dark conditions at 25° C. for 2 weeks.

The results of the experiment are displayed in the following Table VIII, where it is shown for a representative embodiment of the invention that the present formulations can be also stored at 25° C. (e.g. on the workbench) for at least two weeks without notable degradation.

TABLE VIII
Residual absorbance percentage of dye IRDye 800CW (3 μM) in
different organic buffers, after storage at 25° C.

| Time | | |
|---|---|---|
| (weeks) | HEPES | MOPS |
| 1 | 100.9% | 99.7% |
| 2 | 98.4% | 97.3% |

### Example 8: Stability of the Phantom Solutions at +2-8° C. During Long-Term Storage

The stability of the formulations under long-term storage conditions was also investigated. In particular, samples of 3 μM IRDye 8000W and 3 μM IRDye 800BK dissolved in HEPES buffer were stored refrigerated at +2-8° C. protected from light exposure for at least 6 months. For the long-term stability study at 2-8° C., samples of.

The results of the experiment are displayed in the following Table IX, where it is shown for some representative embodiments of the invention that the present formulations can be also stored at 2-8° C. for at least six months without notable degradation.

TABLE IX
Residual absorbance percentage of dye IRDye 800CW (3
μM) and IRDye 800BK in HEPES buffer after storage
at +2-8° C. up to six months

| Time | IRDye 800CW | IRDye 800BK |
|---|---|---|
| (months) | (HEPES 50 mM, pH 7.4) | (HEPES 10 mM, pH 7.0) |
| 1 | 99.3% | 99.1% |
| 3 | 97.7% | 94.1% |
| 6 | 96.2% | 93.3% |

### REFERENCES

1. U.S. Pat. No. 9,167,240
2. Gorpas et al., J. Biomed. Opt. 2017, 22(1): 016009
3. US2006-056580
4. De Grand et al., J. Biomed. Opt. 2006, 11(1): 014007
5. Koller et al., Nat. Commun. 2018, 9(1): 3739
6. Hoogstins at al., Mol. Imaging. Biol. 2019, 21(1): 11-18
7. Ter Weele et al., Eur. J. Pharm. Biopharm. 2016, 104: 226-34
8. EP1113822

1. (canceled)

2. The method according to claim 15 wherein the dye is a compound of formula (Ia) 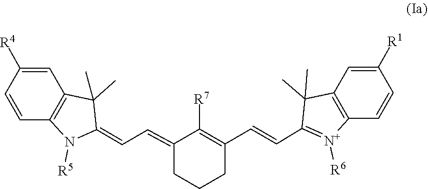
wherein R1 and R4 are each independently selected from hydrogen, —SO₃H, —COOH and —CONHY, where Y is a bivalent alkyl substituted by —SO₃H or at least two hydroxyl groups and R5, R6 and R7 are as defined in claim 15.

3. The method according to claim 2, wherein R1 and R4 are —SO₃H, R5 and R6 are each independently a bivalent alkyl optionally substituted by —SO₃H or —COOH, and R7 is chlorine or —O-phenyl optionally substituted by a group —SO₃H.

4. The method according to claim 3, wherein the dye is a compound selected from sulfo-Cy7, S0456, IRDye 800CW and IRDye 800BK.

5. The method according to claim 15 wherein the dye is a compound of formula (Ib) 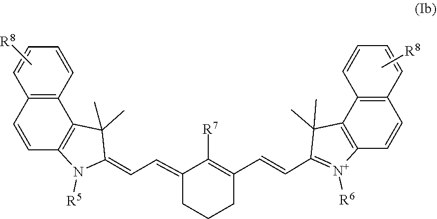
wherein R5, R6 and R7 are as defined in claim 15 and R8 is each independently hydrogen or —SO₃H.

6. The method according to claim 5 wherein the dye is IR-820 or a derivative thereof.

7. The method according to claim 15, wherein the Good's buffer is a zwitterionic biological buffer comprising a bivalent C1-C4 alkyl substituted by a group —SO₃H and/or —COOH.

8. The method according to claim 7, wherein the Good's buffer is selected from the group consisting of MOPS, MES, TRICINE, HEPES, BES, TES, TAPSO and PIPES.

9. The method according to claim 8, wherein the Good's buffer is MOPS, BES, HEPES or TRICINE.

10. The method according to claim 15, further comprising an additive selected from a surfactant, an organic solvent and an antimicrobial compound.

11. The method according to claim 10, wherein the surfactant is selected from Tween 20, Tween 80, PEG 40, PEG 100, PEG 300, PEG 400, PEG 4000, sodium stearate, sodium lauryl sulfate, Triton X-100 and NP-40.

12. The method according to claim 10, wherein the organic solvent is selected from ethanol, methanol, dimethyl sulfoxide, formamide, dimethylformamide and N-methylformamide.

13. The method according to claim 10, wherein the antimicrobial compound is selected from sodium azide and benzyl alcohol.

14. A validation kit for calibrating a fluorescence imaging apparatus comprising a stable formulation comprising a dye of formula (I) 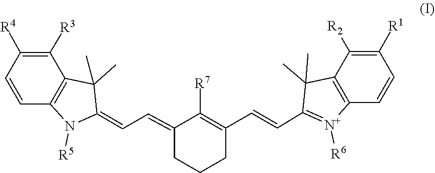
wherein
R7 is selected from hydrogen, chlorine, phenyl and —O-phenyl, optionally substituted by a group —SO₃H, —COOH, —CONH—Y, -alkyl-COOH or -alkyl-CONH—Y, where
Y is a bivalent alkyl substituted by —SO₃H or at least two hydroxyl groups;
R1, R2, R3 and R4 are each independently selected from hydrogen, —SO₃H, —COOH and —CONHY, where Y is a bivalent alkyl substituted by —SO₃H or at least two hydroxyl groups, or R1 together with R2 and R3 together with R4 form respectively a benzo-group, optionally substituted by at least one —SO₃H group; and
R5 and R6 are each independently a bivalent alkyl optionally substituted by a group selected from —SO₃H, —COOH and —CONH₂;
which is dissolved in a Good's buffer,
contained in a primary packaging for fluorescence detection selected from a tube, a vial, an ampule, a syringe, a cuvette, and a multi-well plate with lid.

15. A method of calibrating a fluorescence imaging apparatus, comprising the steps of:
a) exposing a stable formulation comprising a dye of formula (I) 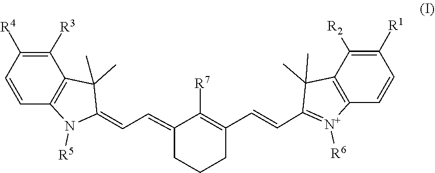
wherein
R7 is selected from hydrogen, chlorine, phenyl and —O-phenyl, optionally substituted by a group —SO₃H, —COOH, —CONH—Y, -alkyl-COOH or -alkyl-CONH—Y, where
Y is a bivalent alkyl substituted by —SO₃H or at least two hydroxyl groups:
R1, R2, R3 and R4 are each independently selected from hydrogen, —SO₃H, —COOH and —CONHY, where Y is a bivalent alkyl substituted by —SO₃H or at least two hydroxyl groups, or R1 together with R2 and R3 together with R4 form respectively a benzo-group, optionally substituted by at least one —SO₃H group; and
R5 and R6 are each independently a bivalent alkyl optionally substituted by a group selected from —SO₃H, —COOH and —CONH₂; which is dissolved in a Good's buffer and contained in a primary packaging for fluorescence detection
to an excitation source of the fluorescence system;
b) collecting the fluorescence emission with a detection system;
c) recording the fluorescence data with a computerized system.
